(19) United States
(12) Patent Application Publication
(10) Pub. No.: US 2009/0047594 A1
(43) Pub. Date: Feb. 19, 2009

(54) Developer

(75) Inventor: Hiroyuki Hirakawa, Nara (JP)

Correspondence Address: Edwards Angell Palmer & Dodge LLP, P.O. Box 55874, Boston, MA, 02205, US

(73) Assignee: Sharp Kabushiki Kaisha, Osaka (JP)

(21) Appl. No.: 12/008,472

(22) Filed: Jan. 11, 2008

(30) Foreign Application Priority Data
Jan. 12, 2007 (JP) 2007-005096

(51) Int. Cl. G03G 9/113

(52) U.S. Cl. 430/111.1

(57) ABSTRACT

A developer according to the present invention is arranged such that the composition of particulate metal oxide added as an external additive to a toner surface and the composition of particulate metal oxide added to a resin layer covering a carrier surface are identical to each other, so that the amount of frictional charge that is generated between the toner and the external additive is made larger than the amount of frictional charge that is generated between the external additive and the carrier surface. With this, the external additive is prevented from migrating from the toner surface onto the carrier surface. This makes it possible to prevent the external additive from migrating from the toner surface onto the carrier surface, and thereby to remedy (i) defects in charge and fluidity and (ii) secondary failures, i.e., defects in development that are caused by deterioration in performance of the developer due to the defects in charge and fluidity.

This Nonprovisional application claims priority under U.S.C. § 119(a) on Patent Application No. 005096/2007 filed in Japan on Jan. 12, 2007, the entire contents of which are hereby incorporated by reference.

### FIELD OF THE INVENTION

The present invention relates to developers for use in formation of images, for example, by electrophotographic, electrostatic recording apparatuses. Particularly, the present invention relates to a two-component developer containing toner and carrier that imparts electric charge to the toner.

### BACKGROUND OF THE INVENTION

According to electrophotographic methods, a visible image is obtained by developing, with use of colored particles called toner, an electrostatic latent image formed on a photoreceptor. Further, among such development methods, a two-component development method uses a developer containing toner and carrier that serves as magnetic particles for imparting electric charge to the toner. Moreover, in order to improve fluidity and charging characteristics, an inorganic powder called an external additive is added to a surface of the toner.

Patent Document 1 discloses, in relation to such a two-component development method using such a developer containing toner and carrier as described above, toner that contains a micronized silica powder, serving as an external additive, whose surface has been covered with a mixture of tin oxide and antimony. According to this arrangement, the toner to which the conductive external additive has been added has a lower electrical resistance, and therefore is stably charged. Further, because the micronized silica powder used as a core of the external additive is inexpensive, the electrical conductivity of the expensive tin oxide and antimony can be effectively used. Furthermore, the micronized silica powder whose surface has been covered with tin oxide and antimony makes it possible to remarkably improve the fluidity of the toner.

However, the developer of Patent Document 1, which is a mixture of toner and carrier, is stirred in a developing unit so that the toner is electrically charged. This causes such a problem that the external additive on the toner surface migrates onto a surface of the carrier. When part of the external additive on the toner surface has migrated onto the carrier surface and the external additive has thus adhered to both the toner and carrier surfaces, the external additive prevents the toner and carrier surfaces to make contact with each other. This reduces the chance of contact charging, and also decreases the amount of charge of the toner.

Possible factors in the migration of the external additive from the toner surface onto the carrier surface include influences, for example, of a charge state of the external additive, a charge state of the toner retaining the external additive, and of a charge state of the carrier surface onto which the external additive migrates. Further, generally speaking, a micronized silica powder, serving as an external additive, whose surface has been hydrophobated is strongly negatively charged, and therefore is likely to adhere to a positively-charged carrier surface.

Thus, the migration of the external additive onto the carrier surface not only impairs the fluidity of the toner but also squander an opportunity for normal contact charging, thereby causing a decrease in amount of charge of the toner. The following describes methods known as measures for suppressing the migration of the external additive onto the carrier surface in order to prevent failures caused by the migration of the external additive onto the carrier surface.

Patent Document 2 discloses, in relation to a one-component development method which unlike the aforementioned two-component development method, uses only toner to which an external additive has been added, an arrangement in which the external additive given to the toner is prevented from moving to a toner-conveying member provided in a developing device. The conventional developing device using the one-component development method has had such a problem that a decrease in toner fluidity caused when the external additive added to the toner has migrated onto a surface of a developing sleeve for conveying the toner causes a decrease in the capability to supply electric charge to the toner on that surface of the developing sleeve to which the external additive has adhered. Further, the external additive having adhered to the surface of the developing sleeve increases in amount of charge by repeating friction, and causes the toner to adhere again to the external additive. As a result, the external additive serves as a core that causes the toner to be fused with the surface of the developing sleeve.

That is, since the one-component development method does not use carrier, the one-component development method has no problem caused by the migration of the external additive onto a carrier surface. However, the one-component development method has such a problem that a decrease in the precision of development is caused when the external additive has migrated onto or remains on the surface of the developing sleeve for conveying the toner in the device. That is, the one-component development method also requires measures for preventing the migration of the external additive. Patent Document 2 discloses the following measures for preventing the migration of the external additive.

As described in Patent Document 2, generally speaking, the adhesion with which two objects adhere to each other mainly by electrostatic force depends on the magnitude of electric charge corresponding to the amount of frictional charge generated between the two objects. The durability of the developer is stabilized by generating strong electrostatic adhesion between the external additive and the toner in order to cause the toner to stay on the toner surface and to prevent the toner from migrating onto the surface of the developing sleeve. That is, the developer is arranged to be such a material that the capability of the toner to impart frictional charge to the external additive is greater than the capability of the developing sleeve to impart frictional charge to the external additive.

Further, in relation to a two-component development method using toner and carrier, Patent Document 3 provides the toner with organic resin microparticles, serving as an external additive, which have a polarity opposite to the toner when the toner and the carrier are charged by friction, thereby improving the rising characteristic of charge of the toner and stabilizing the charging characteristics over time.

For example, in cases where a developer containing negatively-charged toner and positively-charged carrier is used, organic resin microparticles given as an external additive to the toner become positively charged by friction with the carrier. When the selected organic resin microparticles have such properties as to actively migrate to the carrier, the organic resin microparticles become positively charged at an early stage of stirring, depart from the toner, and leave negative charge on the toner surface. As a result, even when the matrices of toner particles are not highly charged, the positively-charged organic resin microparticles depart from the toner, so that the amount of negative charge of the toner can rapidly increase.

Further, in cases where the toner retains abnormally high negative electric charge after the developer has been stirred sufficiently, the positively-charged organic resin microparticles, which have migrated onto the carrier surface, are designed to migrate back to the toner. As a result of such a remigration of the positively-charged organic resin microparticles, the negative electric charge of the toner is neutralized by the positive charge of the organic resin microparticles, so that excessive electrical charge is suppressed. This makes it possible to maintain a desired stable amount of saturation charge.

Furthermore, in relation to carrier, formed so as to be covered with a covering layer containing a micronized conductive powder and a resin, which is used in a two-component development method, Patent Document 4 discloses such a developer that the work function of the resin that constitutes the covering layer is set to be a predetermined numerical value. The developer can maintain such a sufficient rate of rise of charge and such an appropriate level of charge that the carrier can be prevented from being contaminated by an external additive and the like.

The experimental result of Patent Document 4 shows that the rate of rise of charge tends to increase as the value of the work function of the carrier surface decreases and, in particular, that the desired rising characteristic of charge is obtained by using such a resin that the work function of the carrier surface is not more than 4.5 eV. Examples of such a resin, used for a resin covering layer for covering a carrier surface, whose work function does not exceed 4.5 eV include a graft copolymer of polyethylene glycol, polyvinyl alcohol, or the like and styrene acrylate. Further, a covering resin combined with a fluorocarbon resin or a silicone resin can be used.

Further, in order to control the resistance of the carrier of Patent Document 4 within a range of 10⁷ Ωcm to 10² scm, the carrier has a covering material to which a micronized conductive powder has been added. The addition of the micronized conductive powder to the resin covering layer of the carrier surface makes it possible to prevent the amount of charge of the toner from becoming too high, and to improve the rising characteristic of charge of the toner.

Furthermore, the use of an external additive can be minimized by selecting such a resin as described above. Even if an external additive is used, a sufficient rate of rising of charge is obtained by using as small an amount of external additive as possible. This makes it possible to minimize the contamination of the carrier by the external additive.

Further, Patent Document 5 discloses, in relation to a two-component development method, such a negatively-charged toner composition that (i) external-additive-containing toner to which an external additive has been added and (ii) external-additive-free toner to which no external additive has been added are mixed so that the ratio in amount of charge between the two types of toner becomes constant. This reduces the influence of the external additive on the charging characteristics of the toner.

Specifically, such toner is selected as to have such properties that the ratio in amount of charge between the external-additive-free toner and the external-additive-containing toner is not more than 0.5 under certain stirring conditions. For example, the negatively-charged toner composition is constituted by: a negatively-charged main resin having acid value of 5 to 50; a colorant, serving as pigment, which is more positively charged than the main resin on the triboelectric series; and a negatively-charged charge control agent. Meanwhile, the composition of carrier is not particularly limited.

Moreover, when a micronized silica powder having a primary particle diameter of 0.002 μm to 0.2 μm is added as an external additive to toner composed of the aforementioned composition, toner having a uniform amount of charge is obtained without causing only silica particles to preferentially adhere electrostatically to the carrier surface when the toner and the carrier make contact with each other. Further, even if an increase in charge or a charge leakage is caused when the external additive is affected by the environmental moisture, there is no change in developing characteristic even after long-term use. This is because the external-additive-free toner has good charging characteristics.

### [Patent Document 1]

Japanese Unexamined Patent Application Publication No. 68956/1991 (Tokukaihei 3-68956; published on Mar. 25, 1991)

### [Patent Document 2]

Japanese Unexamined Patent Application Publication No. 274364/1997 (Tokukaihei 9-274364; published on Oct. 21, 1997)

### [Patent Document 3]

Japanese Unexamined Patent Application Publication No. 142561/1992 (Tokukaihei 4-142561; published on May 15, 1992)

### [Patent Document 4]

Japanese Unexamined Patent Application Publication No. 179353/1997 (Tokukaihei 9-179353; published on Jul. 11, 1997)

### [Patent Document 5]

Japanese Unexamined Patent Application Publication No. 64558/1990 (Tokukaihei 2-64558; published on Mar. 5, 1990)

### [Non-patent Document 1]

Murata, Y.: “Contact charging”, Kotai Butsuri, 27 (7): 501-509 (1992)

According to the technique of Patent Document 3, it is predicted that an expected effect is obtained in a series of processes during which the stirring of an uncharged developer causes the toner to start to be so charged as to be saturated with charge. However, the desired amount of saturation charge cannot be maintained, for example, in cases where such a developer stirring process is adopted that an operation of stirring a developer is suspended at an early stage of stirring and resumed after a while.

That is, in cases where the organic resin microparticles migrate from the toner to the carrier at an early stage of stirring and the next stirring is started therefrom, the toner no longer contains any organic resin microparticles that will migrate to the carrier. In such a case, the organic resin microparticles cannot fulfill their expected function of compensating the rising characteristic of charge at an early stage of stirring. Further, it is commonly recognized that the organic resin microparticles are easily worn or squashed when the toner and the carrier rubbed with each other at the time of stirring. Therefore, the organic resin microparticles cannot be expected to stably exist in the developer over a long period of time.

Further, even the arrangement of Patent Document 4 has a difficulty in actually eliminating the use of an external additive. Therefore, when the developer is used over a long period of time, the surface of the carrier is contaminated by the external additive and the like. This makes it impossible to completely solve the problem of aged deterioration in amount of charge.

Furthermore, in such a developer for use in a two-component development method as described above, it is the charging characteristics of toner, carrier, and an external additive that contribute directly to the stabilization of charge. Therefore, the toner composition of Patent Document 5 has no particular problem in cases where the external additive is not away from the toner. However, in cases where the external additive is away from the toner, there remains a factor that impairs the stabilization of charge.

Further, as disclosed in Patent Document 5, the toner one of whose components is pigment containing an amine-containing monomer is highly capable of imparting negative charge to an external additive typified by silica, and therefore causes an increase in amount of positive charge that is generated on the toner surface when the external additive peels from the toner. This results in such a problem that the total amount of charge of the negatively-charged toner is reduced.

Main factors in controlling the behavior of an external additive, such as the retention of the external additive on the toner surface and the migration of the external additive onto the carrier surface, are determined by the charging characteristics of the external additive, the interaction between the external additive and the toner surface, and the interaction between the external additive and the carrier surface. As described above, it is not until the properties of carrier as well as toner are considered that the amount of charge of the toner can be stabilized.

Generally speaking, in order to yield a developer that is charged at a high rate of rise, such a method is known that insulating particles, such as silica or alumina, whose surfaces have been treated with a coupling agent are added to the toner surface, or that semiconducting microparticles such as titanium oxide are added as an external additive to the toner. The larger the amount of such additives is, the higher the rate of rise of charge tends to be. However, a method of adding a large amount of external additive to toner cause carrier to be contaminated due to the migration of the external additive, thereby causing secondary failures, such as deterioration in quality of the developer due to a decrease in amount of charge, a decrease in fluidity, or the like.

The present invention has been made in view of the foregoing problems. For the purpose of remedying (i) defects in charge and fluidity that are caused by the migration of an external additive from toner to a carrier surface and (ii) secondary failures, i.e., defects in development that are caused by deterioration in performance of a developer due to the defects in charge and fluidity, the present invention has as an object to provide a two-component developer that makes it possible to always obtain high-quality images stably with high reproducibility by minimizing a change over time in amount of charge of the toner.

### SUMMARY OF THE INVENTION

In order to solve the foregoing problems, a developer according to the present invention contains: carrier having a core material whose surface is covered with a resin layer containing particulate metal oxide; and toner whose surface has particulate metal oxide added thereto, the metal oxide contained in the resin layer and the metal oxide added to the toner having identical compositions.

According to the foregoing arrangement, the developer contains the toner and the carrier that imparts charge to the toner. For the purpose of improving the charging characteristics of the toner, the fluidity of the developer, and the like, the particulate metal oxide is added as an external additive to the toner surface. The carrier surface is covered with the resin layer containing the particulate metal oxide. Moreover, the composition of the metal oxide added as the external additive to the toner is identical to the composition of the metal oxide contained in the resin layer covering the carrier surface.

With this, the amount of frictional charge that is generated between the toner and the external additive can be made larger than the amount of frictional charge that is generated between the external additive and the carrier surface. This brings about an effect of minimizing a change over time in the amount of charge of the toner by preventing the external additive from migrating from the toner surface onto the carrier surface. As a result, it is possible to remedy (i) defects in charge and fluidity that are caused by the migration of the external additive onto the carrier surface and (ii) secondary failures in developing process, i.e., defects in development that are caused by deterioration in performance of the developer due to the defects in charge and fluidity. This makes it possible to obtain high-quality images stably with high reproducibility by preventing images from deteriorating due to continuous use.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 shows a state of metal oxide particles added to a resin layer covering a carrier surface.

FIG. 2 shows a change over time in amount of specific charge of toner in cases where the toner and carrier whose resin layer contains silica particles are mixed and stirred together.

### DESCRIPTION OF THE EMBODIMENTS

The adhesion with which two target objects adhere to each other mainly by electrostatic force when the two objects make contact with each other depends on the magnitude of electric charge generated in accordance with the amount of frictional charge generated between the two objects. In view of this, the inventors diligently studied the migration of an external additive from toner onto a carrier surface. As a result, the inventors concluded that the migration of an external additive onto a carrier surface is dominated by the magnitude of amount of frictional charge generated between the external additive and the target material, and finally completed the present invention.

The migration of an external additive from toner onto a carrier surface is determined by the power relationship between (i) the adhesion F1 attributed to the amount of frictional charge generated between the toner and the external additive and (ii) the adhesion F2 attributed to the amount of frictional charge generated between the carrier and the external additive. Note that the frictional charge between the toner and the external additive is generated in a process step of adding the external additive to the toner. Further, the frictional charge between the carrier and the external additive is generated in a process step of, by mixing and stirring the toner to which the external additive has been added and the carrier, giving charge to the toner.

When F1>F2, the external additive is retained by the toner, and therefore does not migrate onto the carrier surface. However, when F1<F2, the external additive is likely to migrate onto the carrier surface. That is, in order to prevent the external additive from migrating from the toner onto the carrier surface, it is necessary to arrange a developer by combining the characteristics of the toner, the carrier, and the external additive so that the amount of frictional charge that is generated between the toner and the external additive exceeds the amount of frictional charge that is generated between the carrier and the external additive. In view of this, the present invention is arranged as described below.

A developer according to the present invention contains: carrier having a core material whose surface is covered with a resin layer containing particulate metal oxide; and toner whose surface has particulate metal oxide added thereto, the particulate metal oxide serving as an external additive that imparts a predetermined characteristic to the developer, the metal oxide contained in the resin layer and the metal oxide added to the toner having identical compositions.

The external additive is added to the toner surface for the purpose of imparting a predetermined characteristic to the developer. The external additive is used especially for the purpose of improving the fluidity of the developer or improving charging characteristics by supplementary charging. Further, the carrier imparts charge to the toner by being mixed and stirred together with the toner. It is necessary that the particulate metal oxide contained in the resin layer covering the carrier surface be uniformly dispersed in the resin layer, and that at least part of the particulate metal oxide protrude from a surface of the resin layer.

With this, when the toner and the carrier are mixed and stirred together, the external additive on the toner surface makes contact with that part of the particulate metal oxide which protrudes from the surface of the resin layer covering the carrier surface. Since the composition of the particulate metal oxide serving as the external additive and the composition of the particulate metal oxide covering the carrier surface are identical to each other, the amount of frictional charge generated between the carrier surface and the external additive becomes smaller then the amount of frictional charge generated between the external additive and the toner, so that the external additive can be prevented from migrating from the toner onto the carrier surface.

The relationship between the type of material and the charge exchange at the time of contact is attributed to the respective charging characteristics of materials making contact with each other, and is evaluated simply by an index called a triboelectric series (see Non-patent Document 1). The triboelectric series is a list of materials that are charged, arranged in such an order that a material likely to be positively charged is above a material likely to be negatively charged. The measurement of the amount of frictional charge generated when two materials selected from the triboelectric series are rubbed with each other shows that the amount of frictional charge generated between materials farther away from each other in the triboelectric series is larger than the amount of frictional charge generated between materials nearer to each other in the triboelectric series. That is, the amount of frictional charge generated between two material having identical compositions is smallest.

In the developer according to the present invention, when the toner whose surface has the metal oxide added thereto makes contact with the resin layer covering the carrier surface, the metal oxide on the toner surface makes contact with the metal oxide contained in the resin layer covering the carrier surface, so that frictional charge is generated. At this time, since the composition of the metal oxide on the toner surface and the composition of the metal oxide contained in the resin layer covering the carrier surface are identical to each other, the amount of frictional charge thus generated is small. This makes it possible to minimize the adhesion attributed to the amount of frictional charge generated between the external additive and the carrier surface. The minimization of the adhesion between the external additive on the toner surface and the carrier surface makes it possible to weaken the force by which the external additive on the toner surface migrates (adheres) onto the carrier surface. This makes it possible to keep the external additive retained on the toner surface.

Further, the developer according to the present invention is preferably arranged such that the metal oxide added to the toner has a particle diameter that is equal to or larger than the particle diameter of the metal oxide contained in the resin layer. This is based on the following grounds. The toner is charged by repeatedly making contact with the carrier surface. Therefore, the metal oxide added to the toner and the metal oxide contained in the resin layer must be added so that the toner is not deprived of opportunities to make contact with the carrier surface. The amount of charge of toner is the sum of the amount of charge of the matrices of toner particles and the amount of charge of metal oxide added thereto. Therefore, the toner matrices and the metal oxide added thereto must both repeatedly make contact with the carrier surface. In cases where the carrier surface at the time of contact has metal oxide whose particle diameter is larger than the particle diameter of the metal oxide added to the toner, at least the toner matrices cannot make contact with the carrier surface. This makes it impossible to give a desired amount of charge to the toner. Therefore, in order to satisfy a good state of contact, the aforementioned conditions are required. In addition, the migration of the external additive onto the carrier surface can be prevented when the amount of frictional charge generated between the external additive and the carrier surface is made smaller than the amount of frictional charge generated between the toner and the external additive.

In view of this, the developer according to the present invention is arranged such that the particle diameter of the metal oxide contained in the carrier surface is made smaller than the particle diameter of the metal oxide contained in the external additive. With this, the amount of frictional charge that is generated between the external additive and the carrier surface is made smaller than the amount of frictional charge that is generated between the toner and the external additive. At the same time, a good state of contact between the toner and the carrier can be maintained. This makes it possible to prevent the external additive from migrating onto the carrier surface.

The developer according to the present invention is preferably arranged such that, when the metal oxide added to the toner is particulate metal oxide having an average particle diameter of 80 nm to 150 nm, the average particle diameter of the metal oxide contained in the resin layer ranges from 20 nm to 80 nm. Further, examples of the metal oxide added to the toner and the metal oxide contained in the resin layer in the developer according to the present invention include, but are not limited to, silicon oxide, titanium oxide, calcium carbonate, calcium silicate, and magnesium carbonate. Metal oxide other than those named above can be added to the toner contained in the developer according to the present invention and to the resin layer covering the surface of the carrier contained in the developer according to the present invention, provided the metal oxide can be arranged so as to improve the charging characteristics of the toner and to suppress the migration of the external additive onto the carrier surface.

Further, for example, in cases where magnetic particles having an average diameter of 35 μm to 90 μm is used as a core material of the carrier contained in the developer according to the present invention, it is preferable that the resin layer, made of a silicone resin, a fluorocarbon resin, or the like, which covers a surface of the core material have a thickness of 0.1 μm to 5 μm.

### EXAMPLES

### 1. Arrangement of the Developer

As the toner contained in the developer according to the present invention, toner containing internal additives such as a binder resin serving as a binding resin agent, a colorant, a charge control agent, and wax serving as a mold-releasing agent was used. A micronized silica powder that has been hydrophobated was added as an external additive to a surface of the toner particle. Components of the toner are not limited to those named above, and may be those publicly known. As the binder resin added as an internal additive to the toner, a polyester resin was used. As cyan, yellow, magenta, and black colorants, phthalocyanine blue, quinoline yellow, pigment red, and carbon black were used, respectively. Further, as the charge control agent, an azo metal-complex compound was used. As the mold-releasing agent, low-molecular-weight polyethylene was used. The average diameter of the toner used was 6.5 μm.

As the micronized silica powder added as an external additive to the toner, silicon dioxide was used which had been generated by a vapor-phase method of hydrolyzing silicon tetrachloride by heating in an oxyhydrogen salt. The particle diameter of the silica particles ranged from 30 nm to 180 nm, and the average particle diameter was 80 nm. Two parts by weight of silica particles were added to the weight of the toner. The silica particles were hydrophobated by a publicly-known technique. That is, the silica particles were subjected to surface treatment with hexamethyldisilazane, dimethyldichlorosilane, or the like.

As the carrier particles contained in the developer, magnetic particles having a particle diameter of 50 μm and covered with a resin were used. The magnetic particles were covered with the resin by using a conventional coating method. Examples of the conventional coating method include, but are not limited to, a dipping method by which a magnetic particle serving as a core material of carrier is dipped into a solution for forming a resin layer, a spray method by which a solution for forming a resin layer is sprayed over a core material of carrier, and a fluid bed method by which a solution for forming a resin layer is sprayed over a core material of carrier while the core material is being suspended by air.

As a main resin that constitutes the resin layer covering the carrier surface, a silicone resin serving as a low-surface energy material was used. To the silicone resin, five parts by weight of carbon black, one part by weight of quaternary ammonium, and one part by weight of amine were added. Furthermore, to the silicone resin, 2.5 parts by weight of silica particles having an average particle diameter of 35 nm were added. A solution for forming a resin layer only needs to solve the main resin. Examples of the solution include, but are not limited to, toluene, acetone, and tetrahydrofuran.

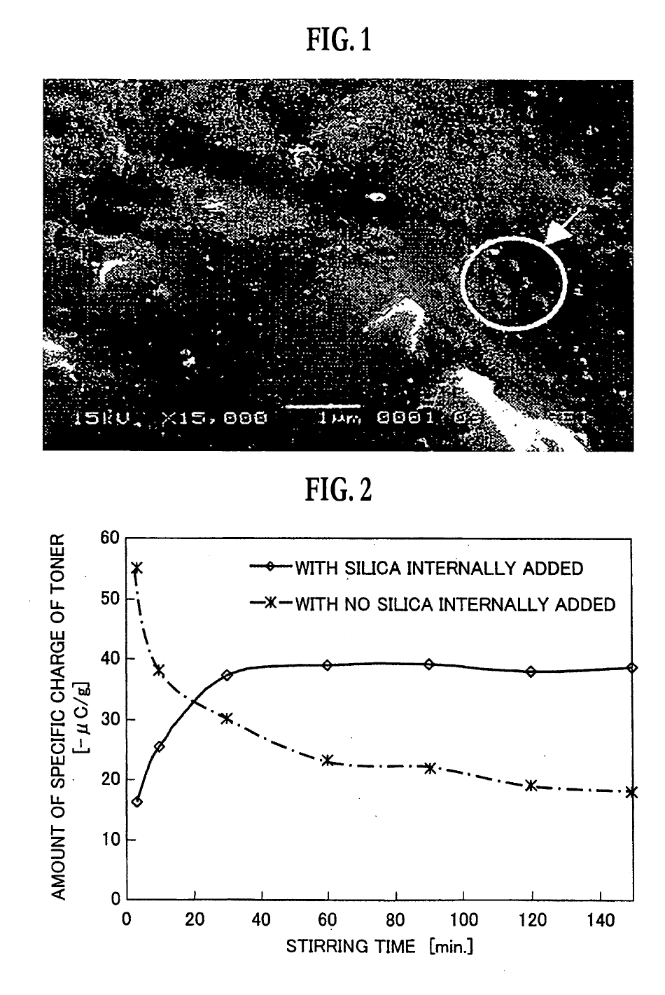

The resin layer covering the carrier surface was formed so as to have a thickness of 0.5 μm to 2 μm. To the resin layer thus formed, the silica particles were added. The silica particles were added to the resin layer so as to be uniformly dispersed in the resin layer and partially protrude from a surface of the resin layer as shown in FIG. 1. FIG. 1 shows a carrier resin layer to which silica particles having an average particle diameter of 100 nm have been added. As seen in the circled range of FIG. 1, the silica particles were added so as to form protruding portions in the resin layer.

With this, when the toner to which the silica particles have been added makes contact with the resin layer of the carrier, the silica particles on the toner surface makes contact with that part of the silica particles which protrudes from the resin layer of the carrier. Therefore, the amount of frictional charge generated between the toner surface and the carrier surface is minimized, so that the adhesion between the toner and the carrier attributed to the amount of frictional charge is also minimized. This causes the silica particles on the toner surface to become less interactive with the carrier surface, so that the silica particles on the toner surface stay on the toner without migrating to the carrier.

### 2. Measurement of the Amount of Charge

The following shows a result obtained by measuring a change in amount of charge of the developer according to the present invention as a function of stirring time. In a polyethylene bottle having a capacity of 50 ml, 19 g of carrier arranged as described above and 1 g of toner arranged as described above were encapsulated. The polyethylene bottle was stirred by rotation with a roll mill rotary stirrer having a revolution speed of 200 rpm. FIG. 2 shows a result obtained by measuring the amount of specific charge of toner C/g (amount of charge of toner/weight of toner) as a function of stirring time. FIG. 2 also shows a comparative example of the developer of the present invention, i.e., a result obtained by measuring the rate of rise of charge when using carrier covered with a resin layer containing no silica particles.

As shown in FIG. 2, when the carrier to which silica particles had been added was used, the toner became saturated with charge within 10 minutes after the start of stirring and the amount of charge was held substantially constant thereafter. On the other hand, when the carrier to which no silica particles had been added was used, there was a sharp rise in the amount of specific charge. The sharp rise was attributed to the fact that the external additive of the toner peels from the toner immediately after the start of stirring. Further, as time advanced, that part of the silica particles which had migrated from the toner onto the carrier and that part of the silica particles which remained on the toner surface prevented the toner and the carrier from making contact with each other. Therefore, the amount of specific charge of the toner was on a declining trend.

Thus, since the developer according to the present invention contains the resin layer covering the carrier surface and the silica particles contained in the toner surface, the use of the developer according to the present invention made it possible to prevent the silica particles from migrating from the toner surface onto the carrier surface. As a result, the toner and the carrier were not prevented from making contact with each other. Therefore, the charge of the toner was stabilized. This made it possible to stably obtain high-quality images.

### 3. Evaluation of the Stability of Charge

The stability of charge was evaluated by using (i) a developer containing such toner as arranged above and carrier whose resin layer contains titanium oxide particles having an average particle diameter of 20 nm, (ii) a developer containing such toner as arranged above and carrier whose resin layer contains silica particles having an average particle diameter of 35 nm, (iii) a developer containing such toner as arranged above and carrier whose resin layer contains silica particles having an average particle diameter of 80 nm, and (iv) a developer containing such toner as arranged above and carrier whose resin layer contains silica particles having an average particle diameter of 100 nm.

When the toner whose surface contains titanium oxide particles having an average particle diameter of 80 nm and the carrier whose resin layer contains titanium oxide particles having an average particle diameter of 20 nm were mixed and stirred together, the charge of the toner was stabilized. The titanium oxide particles have such a resistance as to be defined as a semiconductor, and have a smaller resistance than the silica particles serving as insulating particles. The effect of preventing an external additive from migrating from toner to carrier was the same as when the silica particles were used. However, carrier having a lower resistance is more advantageous to a development process using color toner as a developer. Therefore, carrier whose resin layer contains titanium oxide particles is useful.

In case of the carrier whose resin layer contains titanium oxide particles having an average particle diameter of 20 nm, the external additive does not migrate from the toner to the carrier, so that no defects in charge were caused by the migration of the external additive. However, in cases where the particle diameter of the metal oxide added to the resin layer of the carrier is smaller than 20 nm, there is such a problem that passage of time causes the titanium oxide particles to be embedded in the resin layer. For this reason, the amount of charge of the toner is destabilized in the long term, and proves to be impractical.

When the toner whose surface contains silica particles having an average particle diameter of 80 nm and the carrier whose resin layer contains silica particles having an average particle diameter of 35 nm were mixed and stirred together, the charge of the toner was stabilized (FIG. 2). Also when the toner whose surface contains silica particles having an average particle diameter of 80 nm and the carrier whose resin layer contains silica particles having an average particle diameter of 80 nm were mixed and stirred together, the charge of the toner was stabilized.

In case of the carrier whose resin layer contains silica particles having an average particle diameter of 80 nm, the particle diameter of the silica particles added to the resin layer is too large. Therefore, the carrier prevents the toner from making contact with the carrier, thereby causing charging defects. That is, there is a possibility of such a problem that: the amount of charge of the toner does not increase, so that the desired amount of charge is not obtained.

In view of this, the amount of charge was measured in the following manner by using the carrier whose resin layer contains silica particles having an average particle diameter of 100 nm. When the toner whose surface contains silica particles having an average particle diameter of 80 nm and the carrier whose resin layer contains silica particles having an average particle diameter of 100 nm were mixed and stirred together, the amount of charge of the toner did not increase, so that the desired amount of charge was not obtained.

The present invention is not limited to the description of the embodiments above, but may be altered by a skilled person within the scope of the claims. An embodiment based on a proper combination of technical means disclosed in different embodiments is encompassed in the technical scope of the present invention.

(Other Arrangements)

It should be noted that the present invention can be expressed in the following manners.

(Arrangement 1)

An electrostatic two-component developer for use in an electrophotographic two-component development method, comprising a mixture of: carrier having a resin covering layer that covers a magnetic particle serving as a core material; and toner whose surface contains an external additive including metal oxide particles, the resin covering layer of the carrier containing metal oxide particles whose composition is identical to a composition of the external-additive particles added to the toner surface.

(Arrangement 2)

The two-component developer as set forth in Arrangement 1, wherein the toner contains, as an external additive, titanium oxide particles having an average particle diameter of 80 nm; and the resin covering layer of the carrier contains, as an internal additive, titanium oxide particles having an average particle diameter of 35 nm.

(Arrangement 3)

The two-component developer as set forth in Arrangement 1, wherein the toner contains, as an external additive, titanium oxide particles having an average particle diameter of 80 nm; and the resin covering layer of the carrier contains, as an internal additive, titanium oxide particles having an average particle diameter of 20 nm.

As described above, the developer according to the present invention is arranged such that the particulate metal oxide added to the toner and the particulate metal oxide contained in the resin layer covering the carrier have identical compositions. This brings about an effect of minimizing a change over time in amount of charge of the toner by preventing the external additive from migrating from the toner surface onto the carrier surface. As a result, it is possible to remedy (i) defects in charge and fluidity that are caused by the migration of the external additive from toner onto the carrier surface and (ii) secondary failures, i.e., defects in development that are caused by deterioration in performance of the developer due to the defects in charge and fluidity. This makes it possible to obtain high-quality images stably with high reproducibility by preventing images from deteriorating due to continuous use.

A developer according to the present invention can be applied to an image forming apparatus using a two-component development method.

The developer according to the present invention is preferably arranged such that the metal oxide added to the toner has an average particle diameter that is larger than an average particle diameter of the metal oxide contained in the resin layer.

With this, the amount of frictional charge that is generated between the toner and the external additive can be made larger than the amount of frictional charge that is generated between the external additive and the carrier surface, the external additive can be prevented from migrating from the toner surface onto the carrier surface. This makes it possible to further remedy (i) defects in charge and fluidity that are caused by the migration of the external additive onto the carrier surface and (ii) secondary failures in developing process, i.e., defects in development that are caused by deterioration in performance of the developer due to the defects in charge and fluidity.

The developer according to the present invention is preferably arranged such that the average particle diameter of the metal oxide contained in the resin layer ranges from 20 nm to 80 nm.

The developer according to the present invention is preferably arranged such that the metal oxide is selected from the group consisting of silicon oxide, titanium oxide, calcium carbonate, calcium silicate, and magnesium carbonate.

This makes it possible to prevent the external additive from migrating from the toner surface onto the carrier surface, and to provide a developer having a good rising characteristic of charge of the toner.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A developer comprising:
carrier having a core material whose surface is covered with a resin layer containing particulate metal oxide; and
toner whose surface has particulate metal oxide added thereto,
the metal oxide contained in the resin layer and the metal oxide added to the toner having identical compositions.

2. The developer as set forth in claim 1, wherein the metal oxide added to the toner has an average particle diameter that is equal to or larger than an average particle diameter of the metal oxide contained in the resin layer.

3. The developer as set forth in claim 2, wherein the average particle diameter of the metal oxide contained in the resin layer ranges from 20 nm to 80 nm.

4. The developer as set forth in claim 1, wherein the metal oxide is selected from the group consisting of silicon oxide, titanium oxide, calcium carbonate, calcium silicate, and magnesium carbonate.
